(19) United States
(12) Patent Application Publication
(10) Pub. No.: US 2007/0016505 A1
(43) Pub. Date: Jan. 18, 2007

(54) Method and system for automatically identifying discrepancies from sale of a gift card

(75) Inventors: Jonathan S. Shebson, Los Angeles, CA (US); Lauryn J. Watanabe, Sterling, VA (US); David A. Glettner, Los Angeles, CA (US)

Correspondence Address: Bingham McCutchen LLP, Suite 1800, Three Embarcadero Center, San Francisco, CA, 94111-4067, US

(73) Assignee: HQ GIFT CARDS, LLC a corporation organized and existing under the laws of California, Culver City, CA (US)

(21) Appl. No.: 11/489,406

(22) Filed: Jul. 17, 2006

Related U.S. Application Data
(60) Provisional application No. 60/700,516, filed on Jul. 18, 2005.

(51) Int. Cl. G06Q 40/00; G06Q 99/00; H04L 9/00; H04K 1/00

(52) U.S. Cl. 705/35; 705/64

(57) ABSTRACT

A method and system for automatically identifying discrepancies resulting from the initial sale and servicing of a third party gift card using a central reconciliation system. The central reconciliation system receives and analyzes gift card sale transaction data from multiple sources. A first source is a point of sale, such as a booth or kiosk at a store or shopping center, the second source is a processor, and a third source is a bank. The central reconciliation system receives transaction data associated with the gift card sale from each source and automatically analyzes and compares the data to identify any discrepancies so that any discrepancy can be resolved. Reports can be generated on-demand via menu-driven selections or options showing the discrepancies and reconciliation thereof, and the reports can be accessed by a user via a standard network connection, such as the Internet, or provided to a user.

### CROSS REFERENCE TO RELATED APPLICATION

This application claims priority under 35 U.S.C. §119 of Provisional Patent Application No. 60/700,516 entitled “System and Method for Reconciling Gift Card Transactions” filed Jul. 18, 2005, which is hereby incorporated by reference in its entirety.

### FIELD OF THE INVENTION

The invention generally relates to financial transactions and, in particular, to automatically identifying and reconciling accounting discrepancies resulting from the initial sale and servicing of a gift card.

### BACKGROUND

Prepaid gift cards are becoming increasingly popular and replacing gift certificates to provide customers purchasing power anywhere the gift cards are accepted. Purchasing power using a gift card is thus limited by the programmed value. Common prepaid gift card denominations include $10, $50 and $100, however the funds load on to the gift card are variable from as little as $1 to thousands of dollars. A gift card entitles the purchaser or holder to subsequently purchase products or services at a commercial establishment, such as a store in a shopping mall, up to the programmed or loaded amount. The gift card can be for purchases of multiple retailer products in an individual store, a restaurant, an association or a group of stores (e.g., a mall or shopping center). In general, the gift card is typically redeemable for the programmed or loaded amount.

A gift card appears and functions like a credit card. However, gift cards are significantly different compared to a credit card since a gift card draws upon a pre-programmed, loaded or stored value. A credit card, in contrast, provides a line of credit that must be paid back at a later time. Further, a gift card, as the name implies, is often provided as a gift, whereas credit cards typically are not and remain with the credit card holder. Additionally, gift cards are not discount certificates or coupons since a discount certificate or coupon is redeemed for a discount on a purchase of an item, but does not provide a given programmed value or credit for the purchase of the item itself. Further, discount certificates or coupons typically are not provided as gifts.

Referring to FIG. 1A, one known system 100 for processing the initial sale or purchase of a gift card typically includes a point of sale (POS) 102, a card processor 104 and a bank 106. A POS “sells” the gift card to a customer or purchaser at a store or commercial establishment. The “initial sale” and “initial purchase” are synonymous and are different terms referring to the same initial sale but with respect to different parties in the transaction. For example, when a customer purchases a gift card, the POS 102 of that establishment directly communicates with the gift card processor 104 of the gift card and a banking institution when applicable. The gift card processor, however, typically does not communicate with the banking institution in which the purchased funds are deposited.

Referring to FIG. 1B, conventional up-data flow 150 occurs between a plurality of entities including POS (point of sale) terminals 158, mall management 156, regional-management 154, and port~folio/corporate management 152. In general, the portfolio/corporate management entity 152 represents one or more regional management entities 154, the regional management entities each represent one or more mall management entities 156, and the mall management entities 156 each represent one or more POS terminals 158 that are typically provided in perspective stores within the mall's retail area.

According to one embodiment, one or more POS terminals 158 send transactional data of gift card sales to the mall management 156, the mall management 156 transfers the gift card transactional data to the regional management 154, and the regional management 154 transfers the gift card transaction data to the portfolio/corporate management 152. Hence, transactional data of gift card sales is sent to the portfolio/corporate management 152 via up-data flow. In general, up-data flow refers to the direction of data flow from the POS terminal 158 to the portfolio/corporate management 152.

Reconciling the data generated by the sales of gift cards can be cumbersome since the parties do not reconcile transactions involving gift card sales with each other. The three parties do not check the amount of funds that is loaded matches the funds deposited into the bank which should match the amount sold. Given the lack of an effective tracking and reconciliation system, one or more discrepancies or errors in the reports of one or more parties may arise. For example, one known method of reconciling gift card sales involves an accountant who must manually review individual printed reports from each party involved in the gift card sale to determine whether any discrepancy exits. This manual process is tedious, labor intensive, expensive and time consuming. Moreover, this process can be prone to human error. In addition, the current system relies on reports being prepared by the mall, which is then passed on to the region, which is then passed on to the corporate offices. This method is error prone (e.g. a mall incorrectly calculated it sales, these errors are then rolled all the way up to the corporate office, which effect everyone's sales data). These shortcomings are compounded considering the large number of gift card sales and various POS, bank and processor parties, each of which may utilize different reporting formats which may or may not be compatible.

Accordingly, there exists a need for a method and system that can automatically identify and resolve discrepancies resulting from the initial sale (or purchase) of a gift card without the need for manual analysis. The method and system should achieve these results quickly, easily and accurately. The method and system should also allow users to generate reports showing various transactional data and discrepancies and how the discrepancies can be resolved. The method and system should also be accessible by various parties directly and remotely. Embodiments of the invention fulfill these unmet needs.

### SUMMARY

Embodiments of the invention are directed to a system and method for identifying any discrepancies that may result from the initial sale of a gift card including a third party gift card, e.g., at a shopping mall, store, a group of stores or other high volume commercial establishment.

According to one embodiment, a method for automatically identifying and reconciling a discrepancy resulting from a sale of a gift card includes receiving, at a central reconciliation server, first transactional data from a first source involved in the gift card sale, second transactional data from a second source involved in the gift card sale, and third transactional data from a third source involved in the gift card sale and automatically identifying any discrepancy in the first transactional data, the second transactional data and the third transactional data at the central reconciliation server.

According to one aspect, the method includes generating a report identifying any discrepancy, storing the report in the central reconciliation server and/or providing the report on demand over the Internet to a user. The user manages the gift card sale transaction, wherein the user, for example, is a shopping center or mall. The user may be provided access to the report via a standard network connection (such as the Internet) and on-demand menu-driven selections.

According to another aspect, automatically identifying any discrepancy includes automatically comparing the first transactional data, the second transactional data and the third transactional data from respective first, second and third sources to verify the accuracy of each transactional data received from each source. This may be performed without reliance on user input, and any discrepancy may be automatically reconciled.

According to another aspect, the first transactional data may be received from a point of sale device, a web-based pos application, an apparatus, a system, a store, service booth, a kiosk, online shopping website and/or a shopping center or a mall. The second transactional data may be received from a processor, such as, for example, a stored value processor or issuer. The third transactional data may be received from a bank in which the funds are deposited and swept.

According to another embodiment, a method for automatically identifying and reconciling a discrepancy resulting from a sale of a gift card includes receiving, at a central reconciliation server, first transactional data from a point of sale, second transactional data from a processor of the gift card and third transactional data from a bank. The method includes automatically identifying any discrepancy in the first transactional data from the point of sale, the second transactional data from the processor and the third transactional data from the bank at the central reconciliation server.

According to one embodiment, a system for automatically identifying and reconciling a discrepancy resulting from a sale of a gift card includes a first source that generates an initial request related to the initial sale of a gift card and first transactional data of the gift card sale, a second source that authorizes the request for the initial sale of the gift card and generates second transactional data of the authorization, and a third source that receives funds for the initial sale of the gift card from the first source and generates transactional data of received funds. The system includes a central reconciler that receives the first transactional data from the first source, the second transactional data from the second source, and the third transactional data from the third source and automatically identifies any discrepancy between and/or of the first transactional data, the second transactional data and the third transactional data.

According to another embodiment, a system for automatically identifying and reconciling a discrepancy resulting from a sale of a gift card includes a point of sale that generates a request related to the initial sale of a gift card and first transactional data of the initial gift card sale, a processor that authorizes the request for the initial gift card sale and generates second transactional data of the authorization, and a bank that receives funds for the initial gift card sale from the point of sale and generates transactional data of received funds. The system includes a central reconciler that receives first transactional data from the point of sale, second transactional data from the processor, and third transactional data from the bank, and automatically identifies any discrepancies between and/or of the first, second and third transactional data.

These and other objects and advantages of the present teachings will become more fully apparent from the following description taken in conjunction with the accompanying drawings.

### BRIEF DESCRIPTION OF THE DRAWINGS

FIG. 1A is a block diagram of a conventional gift card processing method;

FIG. 1B is a block diagram of conventional up-data flow;

FIG. 2A is a block diagram of a system for identifying discrepancies resulting from the initial sale of a gift card that includes multiple sources, each of which provides transactional data to a central reconciliation system according to one embodiment of the invention;

FIG. 2B is a block diagram of a system for identifying discrepancies resulting from the initial sale of a gift card including a point of sale, a processor and a bank that provide data to a central reconciliation system according to one embodiment of the invention;

FIG. 2C is a block diagram of direct comparison of the transactional data by the central reconciliation system according to one embodiment of the present invention;

FIG. 2D is a block diagram of down-data flow according to one embodiment of the present invention;

FIG. 3 illustrates reports that can be generated according to embodiments of the invention;

FIG. 4 is a transactional data flow diagram illustrating a method of identifying transactional data flow from the initial sale of a gift card according to one embodiment of the invention; and

FIG. 5 is a flow chart for determining whether any discrepancy results from the initial sale of a gift card according to one embodiment of the invention.

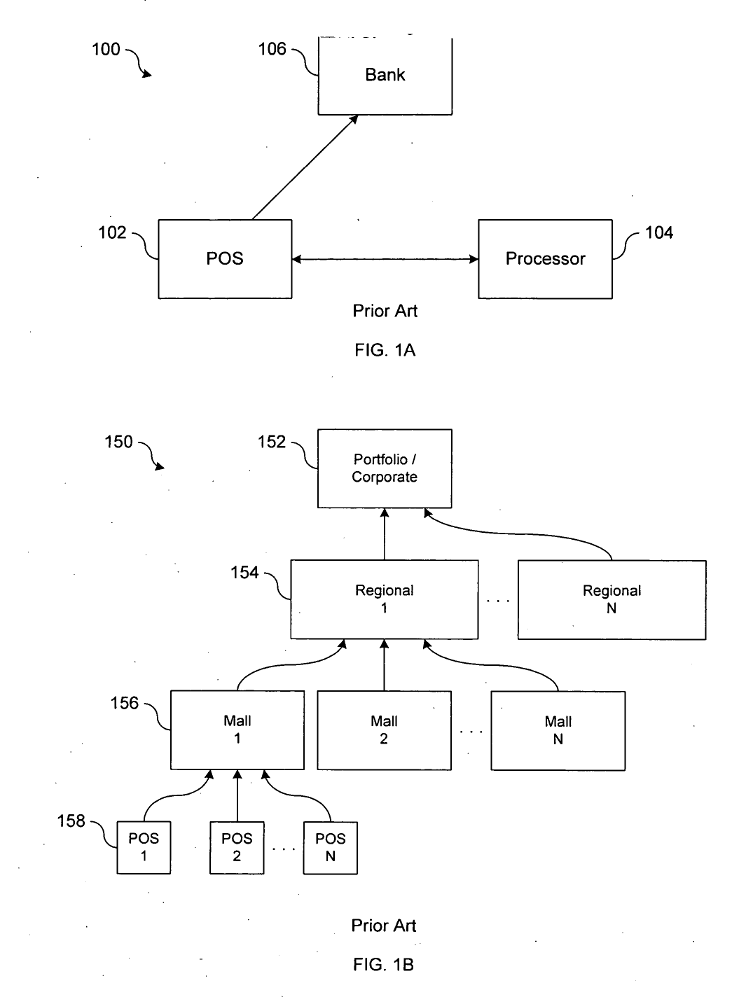

### DETAILED DESCRIPTION OF ILLUSTRATED EMBODIMENTS

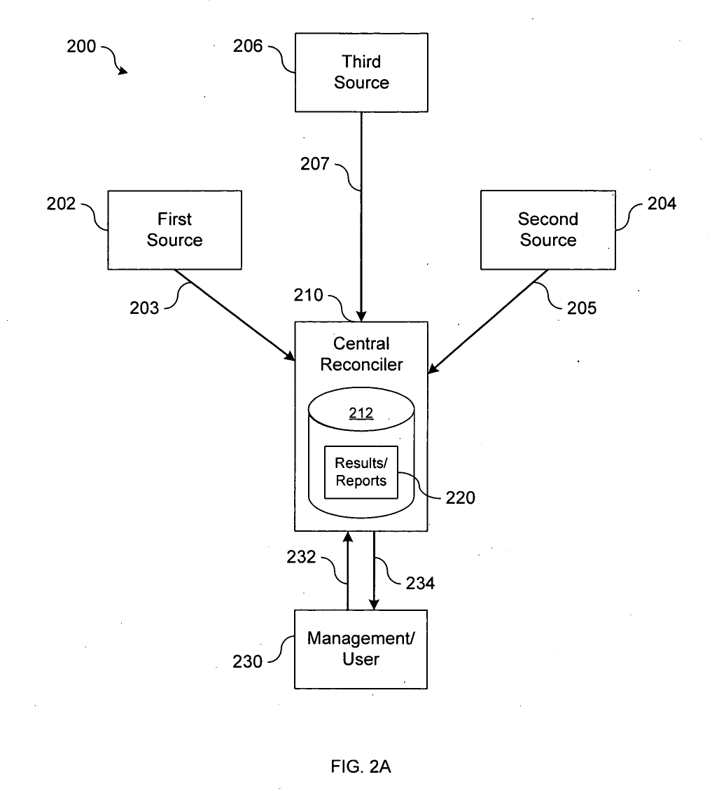

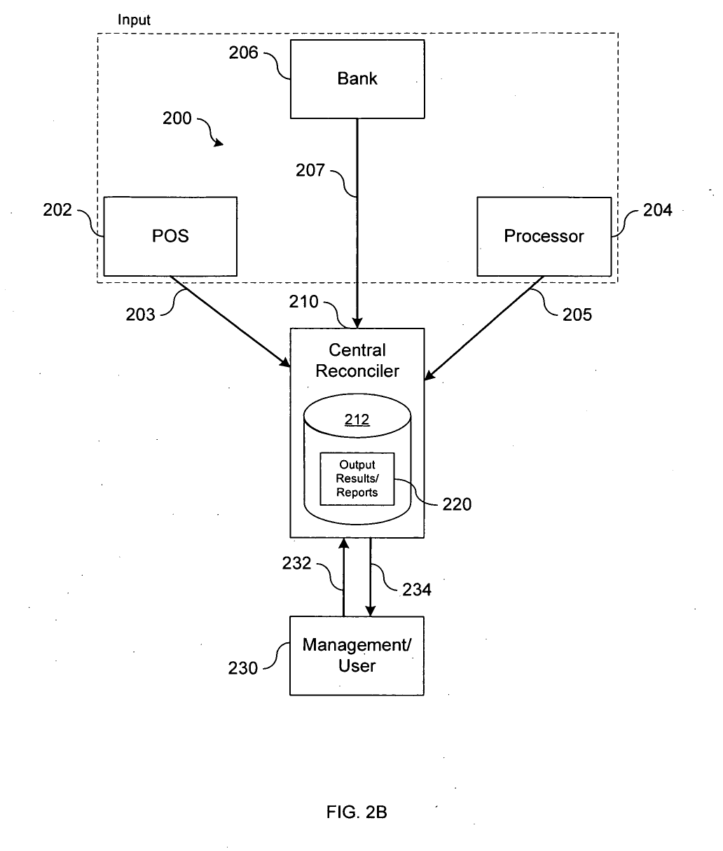

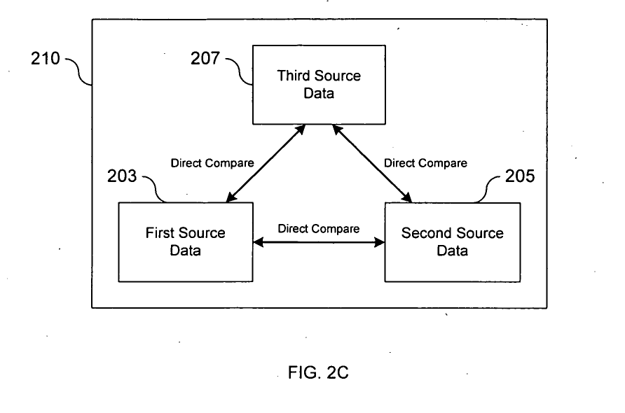

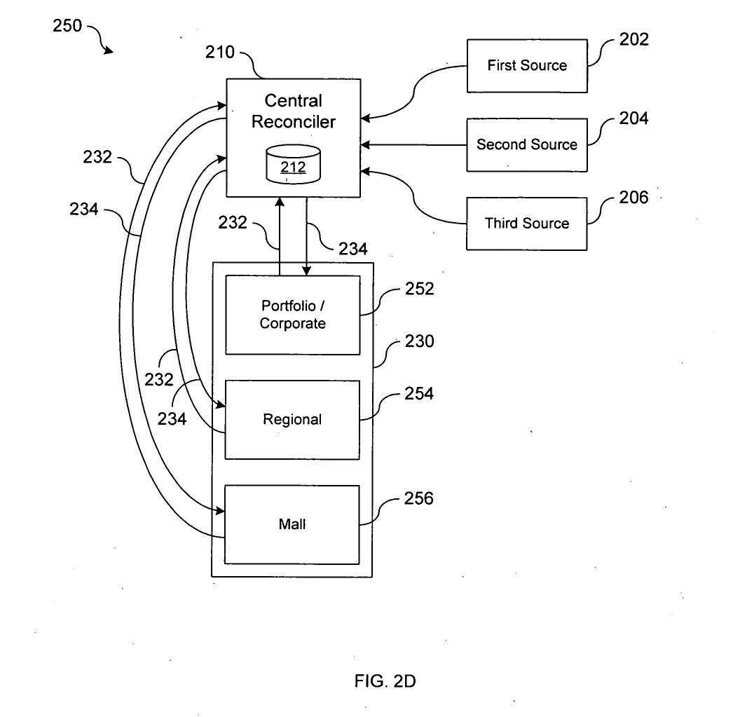

Embodiments of the invention provide a method and system for automatically identifying any discrepancies that may result from a sale of a gift card. Embodiments of the invention are directed to the initial sale and servicing (initial crediting or programming) of a gift card rather than processing subsequent purchases of goods and services using a gift card that was previously purchased programmed. The terms “initial sale” and “initial purchase” are synonymous since they both involve the initial crediting and programming of the gift card relative to different parties in the transaction. Embodiments of the invention provide a central reconciliation system or server that receives transactional data from each party or source involved in the initial sale (or purchase) of a gift card, including a Point Of Sale (POS), a bank and a processor including a stored value processor or issuer. The central reconciliation server, if necessary, formats or converts one or more sets of data from these sources into an understandable or common format, analyzes the data, and advantageously automatically identifies any discrepancies in the data. For example, one of the gift cards may have been in the amount of $100, but for some reason, a discrepancy may result in one of the other parties believing that that the amount programmed was other than $100. The central reconciliation server can also generate an indication of a discrepancy or a report that show transactional data and discrepancies of gift card sales. If any discrepancies are identified, they can then be resolved, e.g., by other research methods as appropriate. These and other advantages of embodiments of the invention are described with reference to FIGS. 2A-5.

Referring to FIG. 2A, according to one embodiment, a system 200 for identifying and reconciling any discrepancies resulting from the initial sale or purchase of a gift card includes a first source or party 202, a second source or party 204, a third source or party 206 and a central reconciler 210. Persons skilled in the art will appreciate that the central reconciler 210 can be a server, a computer or other processing unit or a team of people. For purposes of explanation, not limitation, this specification refers to a central reconciliation server 210.

The first source 202 generates a request to purchase a gift card and first transactional data 203 of the gift card purchase. The first transactional data 203 or first raw data can include files digitally transmitted in an open text format through a transmission network, like the internet, these files contain detailed transaction data of the actual gift card sales processed by the POS. The second source 204 authorizes the request for the gift card purchase and generates second transactional data 205 or second raw data of the authorization. The second transactional data can include files digitally transmitted in an open text format through a transmission network, like the internet, these files contain detailed funding data for funds loaded onto the gift cards. The third source 206 receives funds for the gift card purchase from the first source 202 and generates third transactional data 207 of the received funds. The third transactional data 207 or third raw data can include files digitally transmitted in an open text format through a transmission network, like the internet, these files include summary transactions of the amounts of funds deposited into various bank institutions and commercial banks. Persons skilled in the art will appreciate that the terms “first,” “second” and “third” are used to refer to different sources and transactional data from these different sources. Thus, “first,” “second” and “third” do not refer to a particular sequence or order since different transaction data may generated and provided to the central reconciliation server 210 at the same or different times.

Referring to FIG. 2A, the central reconciliation server 210 receives first transactional data 203 from the first source, second transactional data 205 from the second source 204 and third transactional data 207 from the third source 206. In some instances, one type of data may be in a different format than the other types of data. The central reconciliation server can reformat or reorganize the data (or the data fields) as necessary for subsequent processing and analysis. According to one embodiment, the first, second and third sources 202, 204 and 206 send respective data directly to the central reconciliation server 210, e.g., via a standard communication network, such as a telephone line, a wireless network, the Internet, an Intranet, etc. In the illustrated embodiment, data is transmitted from each source to the central reconciliation server as unidirectional or one-way communications. Thus, the central reconciliation server does not send data to the sources, and the sources do not communicate with each other.

The first, second and third transactional data 203, 205 and 207 are locally stored in the central reconciliation server 210, e.g., in memory, a database, a data store, etc. This specification refers to a database 212 for purposes of explanation. The central reconciliation server 210 analyzes the multiple sets of stored data 203, 205 and 207 and automatically searches for, locates and/or identifies any discrepancies of the transactional data and information received from the first, second and third sources 202, 204, 206. In one aspect, discrepancies can be identified by reviewing the data and looking for inconsistencies, for example the first source data may say that there has been $100 worth of cards sold while the second source data reports that there has only been $97 worth of cards sold. The system compares data 203 to 207 (the correct amount of funds have been loaded on the gift card), then 203 to 205 (the correct amount funds have been deposited into the bank), then 205 to 207 (the correct amount of bank funds to be available for processor or issuer sweeping, and subsequently swept) concurrently. Depending on where the discrepancy is identified, further research is done with the source that does not match the other two sources. The identification of discrepancies occurs throughout the various reporting modules for each data type.

The results 220 of the discrepancy analysis can be stored in the database 212 elsewhere as necessary. The results 220 can be in the form an indicator (whether or not any discrepancy exists). Alternatively, the central reconciliation server can generate a report as, for example, an output report. The report can show whether any discrepancy exists and/or related data relating to the comparisons of the transactional data and information received from each source 202, 204, 206. In addition, the central reconciliation server 210 locally stores the generated reports for each source in the database 212. In addition to the central reconciliation server 210 generating an indication or report, managers or accountants of shopping centers or malls can also directly input supplemental transactional data and information in the server and database. In one aspect, some of the supplemental information can generally be qualitative rather than quantitative including the company name, person name, address phone number that assist in contacting consumers for future promotions and/or include explanation and/or comments for any discrepancy or timing difference; e.g., the management/user can communicate with the central reconciliation server via a standard communication network to provide explanation or comments thereto.

Referring now to FIG. 2B, according to one embodiment, the first source 202 is a point of sale (POS) that provides reporting data on a transaction-by-transaction basis. The POS may be, for example, at a store, a shopping center or a mall. The POS can be within a common area of the shopping center or mall or within an individual store. Further, the POS can be a kiosk or a service booth, such as a self-service kiosk or service booth used by shoppers. In a further embodiment, the POS can be virtual or an online shopping website on a standard communication network, such as the Internet. It should be appreciated that the reconciliation system of the present invention can be used in any high volume multiple retailer location, such as, but not limited to, casinos, resorts, cruise lines, malls, city centers, universities, colleges, etc.

In one aspect, the shopping centers or malls manage login to the POS system through which the cards are sold, manage collection of payments, such as paper payments (cash or check) and credit card payments, e.g., Visa, MasterCard, Discover, Amex, etc., and manage depositing of funds in the shopping center banking institution. The POS provides basic reporting on gift card sales at the transaction level. The transaction data that is received from the POS is disseminated from the POS back to the management and filtered down through the management structure.

As shown in FIG. 2B, according to one embodiment, the second source 204 is a stored value processor or issuer. Stored value processors produce and maintain electronic records that represent the accounts for supporting gift cards. The accounts are generally guaranteed by the issuers who hold funds and make the gift cards available for redemption. Redemption generally rides over electronic fund networks. The processor, like the POS, also provides data on a transaction by transaction basis.

According to one embodiment, the third source 206 is a bank or other similar banking institution, such as a commercial bank where a business or shopping center conducts banking transactions. The bank manages one or more bank accounts. The management office deposits funds into the one or more bank accounts. The funds that can be deposited include cash, check and electronic funds transfer. (EFT) deposits. EFT deposits can include large orders as well as funds received for purchases made with credit cards.

Referring to FIG. 2C, according to one embodiment, the central reconciliation server 210 advantageously automatically identifies any discrepancies in the transactional data 203, 205 and 207 from respective sources 202, 204 and 206 by directly comparing the received transactional data from each source 202, 204, 206 and verifying the similarity of the received transactional data and identifies any differences. The results of this analysis, according to one embodiment, are presented in a summary of the results or a report 220 of FIG. 2B, which may be stored in the database 212 of FIG. 2B.

Referring to FIG. 2D, according to one embodiment, down-data flow 250 occurs between the central reconciliation server 210 and a mall management entity 256, a regional management entity 254, and a portfolio/corporate management entity 252. The central reconciliation server 210 receives transactional data from the sources 202, 204, 206, processes the transactional data by identifying and/or reconciling the transactional data as discussed herein, and then provides via down-data flow one or more reports 220 of any discrepancy analysis to the portfolio/corporate management 252, the regional management 254 and/or the mall management 256, which may include the management/user 230 of FIG. 2A. In general, down-data flow refers to the direction of data flow including report data 220 from the central reconciliation server 210 to the portfolio/corporate management 252, the regional management 254, and the mall management 256 including management/user 230.

According to one aspect, at least the mall management 256 or management/user 230 may access the reports 220 from the central reconciliation server 210 via a standard communication network, including the Internet, email, facsimile, etc.

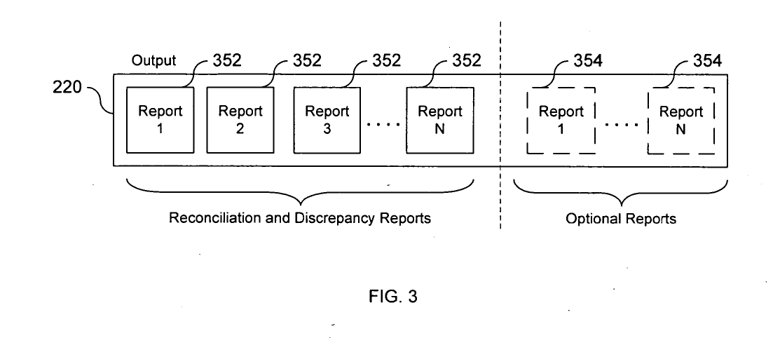

Referring to FIG. 3, the central reconciliation server 210 of FIGS. 2A-2D receives transactional raw data and information from one or more sources that is sometimes unclear and difficult to understand. During processing, the central reconciliation server 210 refines the received raw data into a user-friendly report, and pertinent data is pulled for relevant discrepancy reports. The report 220 can be generated by the central reconciliation server 210, or the data from the reconciler can be provided to another element that generates the report. The received transactional data and information from each source 202, 204, 206 and any generated reports for any of the sources 202, 204, 206 can be stored in the database 212 of the central reconciliation server 210 or another data store or memory.

According to one embodiment, the central reconciler 210 generates at least one report 352 of the reconciled transactional data for each source 202, 204, 206. The one or more generated reports 352 may include discrepancy data and information from any financial transactions, including gift card sales transactions, during a selected period of time with on-demand menu-driven selections or options. The generated reports 352 are formatted through an online web-based application, for example, and can be run in a selected period of time that may refer to daily, weekly, monthly, quarterly, semi-annually and/or annually depending on a desired report schedule or selected dates, products, measurement criteria, etc.

In one embodiment, the types of reports 352 that can be generated include reconciliation reports, discrepancy reports and additional reports 354, such as, but not limited to, inventory reports, resource reports, managements reports, sales reports, corporate sales reports and “paid by mall” reports. The reconciliation type reports may include banking discrepancy reports, credit card discrepancy reports, settlement/processor discrepancy reports, POS discrepancy reports, daily sweep reports, and various other generally known reconciliation type reports. One or more reports can be generated for each source 202, 204, 206 as well as comparing the data received from the links between each source 203, 205, 207.

A banking discrepancy report captures the daily total of cash, checks and credit cards that should have been collected according to the POS apparatus and the amount received by the bank, wherein the discrepancy may include a cash, check & credit card “overs” or “shorts”. Sometimes, a “short” is a source of “slippage” that the mall reimburses out of its own budget each month. Corporate sales reports are used for tracking waived fees for sales analysis and for marketing purposes. Paid by mall entries track how malls spend their marketing budget to supplement the purchase gift cards. Sales reports include a reporting component for comparison of past performance, sales viewed annually, monthly and daily, for example. Inventory management reports monitor the movement of cards at the malls, compare amount of gift cards sold and tracks lost cards that expose the mall to potential fraud, wherein proper inventory management reduces risk and keeps costs low. Monthly statements reports summarize statistics and track mall invoices, slippage, credit card information, settlement, inventory, consumer fees, commissions, sales performance analysis, etc.

The report can be provided 232 (FIGS. 2A-2D) to a user, such as management, accounting or other persons requiring access to the reports. In another embodiment, the central reconciliation server 210 is a server having the database 212 as an integrated part of the server, and a web-based operating system or application. This configuration allows a user to access 234 (FIGS. 2A-2D) and view the report and/or transactional data and related information through a web browser via a standard communication network, such as the Internet, using assigned usernames and passwords. Any discrepancies can then be identified or resolved, e.g., automatically by the central reconciliation server 210.

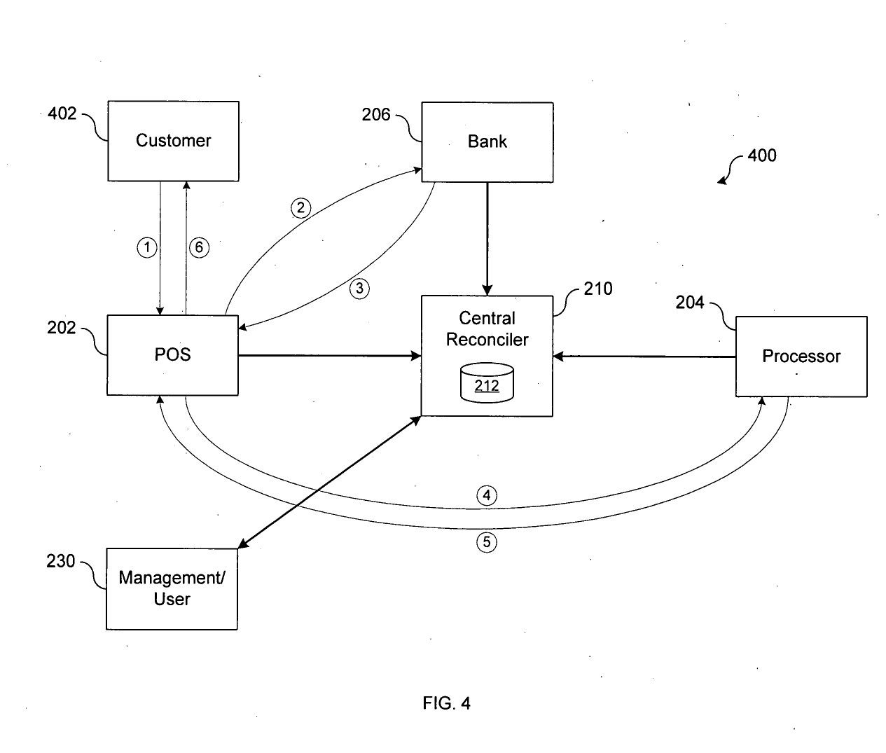

FIG. 4 is a block diagram of an embodiment of a system 400 for reconciling the initial sale of a gift card and further illustrates method steps associated with a gift card purchase and embodiments of the invention that identify any discrepancies resulting from the gift card purchase. A customer or gift card purchaser 402 issues (1) an initial or first request to purchase a gift card from the first source 202, such as the POS 202 (e.g., service booth or kiosk at a store or mall). The request is transferred (2) from the first source or POS 202 to the third source 206, such as the bank. Upon approval, the bank 206 funds the gift card and provides authorization (3) to the POS 202. The request is then transferred (4) from the POS 202 to the second source 204, such as the stored value processor. Authorization for the request is sent (5) from the second source 204 or processor to the POS 202, and the customer receives (6) the gift card from the first source 202. The customer may then, at a later time, use the credited gift card for future use as a financial instrument in retail location or store in the shopping center or mall. Embodiments of the invention, however, are directed to reconciling transactional data associated with the initial sale of a gift card rather than subsequent transactions following the initial sale.

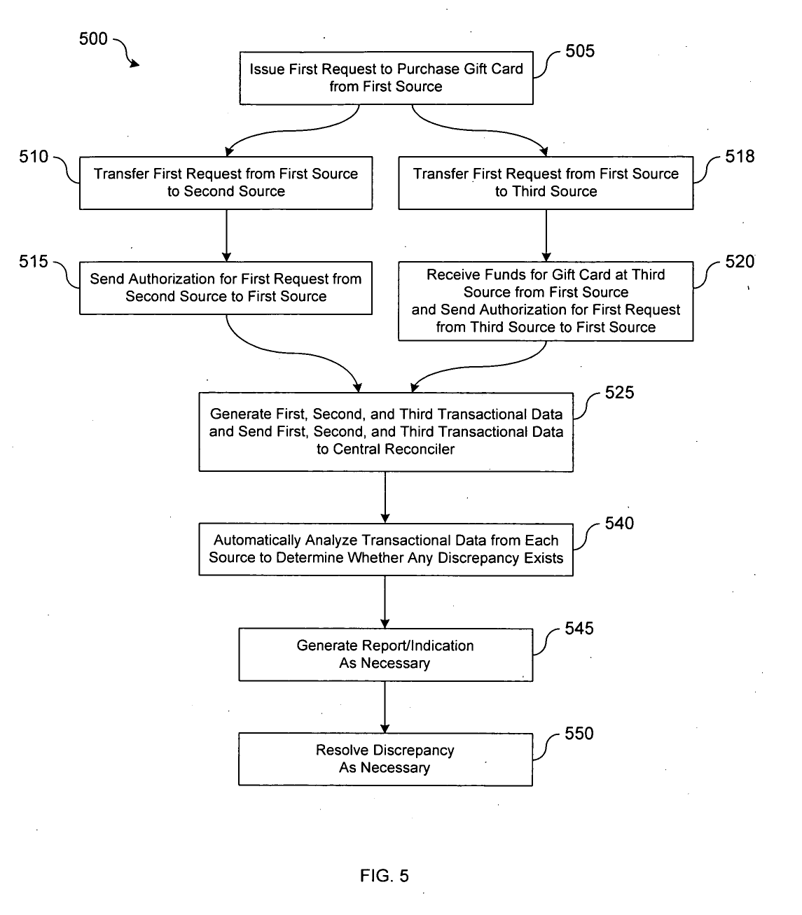

FIG. 5 is a flow diagram illustrating one embodiment of a method 500 for identifying any discrepancies resulting from the initial sale of a gift card. The method 500 includes issuing a first request to purchase a gift card from the first source (e.g., POS) in response to a customer request to purchase a gift card in step 505. The first request is transferred from the first source to the second source (e.g., processor) in step 510, and the second source sends authorization for the first request from the second source to the first source in step 515. Additionally, in step 518, the first request is also transferred from the first source to the third source (e.g., bank), and the third source receives funds for the gift card and sends authorization for the first request to the first source in step 520. Each source generates transactional data corresponding to its respective step in the gift card sale process.

In step 525, the first source generates first transactional data or first raw data and sends this data to the central reconciliation server, the second source generates second transactional data or second raw data and sends this data to the central reconciliation server, and the third source generates third transactional data or third raw data and sends this data to the central reconciliation server. Persons skilled in the art will appreciate that the sources may generate transactional data at the same time and/or at different times. Thus, in various aspects, the central reconciliation server can receive transactional data in parallel from multiple sources, in series, or in parallel from some sources and in series from other sources. Thus, FIG. 5 provides a single step for three separate steps for purposes of explanation and illustration, not limitation.

Continuing with step 540, the central reconciliation server automatically analyzes the data from each source to determine whether there is any discrepancy in the received sets of data. Persons skilled in the art will appreciate that the central reconciliation server can process and analyze data in different sequences and steps. For example, in step 545, if any discrepancy is identified, the discrepancy can be researched. According to one other embodiment, the central reconciliation server can assist with the resolution of any discrepancy. According to still one other embodiment, any discrepancies are automatically identified or resolved to the maximum extent possible by a third party reconciliation server, e.g., by the central reconciliation server.

The system and method of the invention provide for efficient reconciliation of initial sales of gift cards utilizing a central reconciliation server. Embodiments provide a web-based server and a web-based application that provides the user with convenient access to transactional data and information via a standard communication network, such as the Internet. Reconciliation and discrepancy reports can be generated in a time efficient manner and conveniently accessed via the online server and application. Systems and methods of embodiments of the invention compare and analyze transactional data and information from multiple sources (at least three different sources in the illustrated embodiments) involved in the initial gift card sale. The central reconciliation server of the invention can automatically generate daily audits and identify any discrepancies in the transactional data and information received from any of the sources. The received transactional data and information and the generated reports can be stored locally in a database on the central reconciliation server. Thus, embodiments provide significant improvements over known systems, which do not have or utilize a centralized reconciliation system, thereby providing more efficient and accurate reconciliation of gift card sales.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense. These and other embodiments of the present invention may be realized in accordance with the above teachings, and it should be evident that various modifications and changes may be made to the above described embodiments without departing from the broader spirit and scope of the invention. The specification and drawings are, accordingly, to be regarded in an illustrative rather than restrictive sense and the invention measured only in terms of the claims.

What is claimed

1. A method for automatically identifying and reconciling a discrepancy resulting from a sale of a gift card, comprising:
receiving, at a central reconciliation server, first transactional data from a first source involved in the gift card sale, second transactional data from a second source involved in the gift card sale, and third transactional data from a third source involved in the gift card sale; and
automatically identifying any discrepancy in and between the first transactional data, the second transactional data and the third transactional data at the central reconciliation server.

2. The method of claim 1, further comprising generating on demand a report identifying any discrepancy.

3. The method of claim 2, further comprising storing the report in the central reconciliation server.

4. The method of claim 2, further comprising providing the report to a user.

5. The method of claim 4, wherein the user comprises a third party that manages the gift card sale transaction.

6. The method of claim 4, wherein the user is a shopping center or mall.

7. The method of claim 2, further comprising providing a user access to the report via a standard network connection including the Internet.

8. The method of claim 1, automatically identifying any discrepancy further comprising automatically comparing the first transactional data, the second transactional data and the third transactional data from respective first, second and third sources to verify the accuracy of each transactional data received from each source.

9. The method of claim 1 being performed without reliance on user input.

10. The method of claim 1, receiving the first transactional data further comprising receiving first transactional data from a point of sale.

11. The method of claim 10, receiving the first transactional data from the point of sale further comprising receiving first transactional data from a store, a shopping center or a mall.

12. The method of claim 10, receiving the first transactional data from the point of sale further comprising receiving first transactional data from a service booth or kiosk.

13. The method of claim 12, receiving the first transactional data from the point of sale further comprising receiving the first transactional data from a service booth or a kiosk at a store, a shopping center or a mall.

14. The method of claim 10, receiving the first transactional data from the point of sale further comprising receiving first transactional data from an online shopping website.

15. The method of claim 1, receiving the second transactional data further comprising receiving second transactional data from a processor.

16. The method of claim 1, receiving the third transactional data further comprising receiving third transactional data from a bank.

17. The method of claim 1, further comprising automatically reconciling any discrepancy.

18. A method for automatically identifying and reconciling a discrepancy resulting from a sale of a gift card, comprising:
receiving, at a central reconciliation server,
first transactional data from a point of sale,
second transactional data from a processor of the gift card, and
third transactional data from a bank; and
automatically identifying any discrepancy in the first transactional data from the point of sale, the second transactional data from the processor and the third transactional data from the bank at the central reconciliation server.

19. The method of claim 18, further comprising generating on demand a report identifying any discrepancy.

20. The method of claim 19, further comprising storing the report in the central reconciliation server.

21. The method of claim 19, further comprising providing the report on demand to a user.

22. The method of claim 19, further comprising providing a user access to the report via a standard network connection including the Internet.

23. The method of claim 18, automatically identifying any discrepancy further comprising automatically comparing the first transactional data from the point of sale, the second transactional data from the processor, and the third transactional data from the bank to verify the accuracy of each transactional data received from each source.

24. The method of claim 18 being performed without reliance on user input.

25. The method of claim 18, receiving the first transactional data from the point of sale further comprising receiving first transactional data from a service booth or a kiosk.

26. The method of claim 25, receiving the first transactional data from the point of sale further comprising receiving first transactional data from a service booth or a kiosk at a store, a shopping center or a mall.

27. The method of claim 18, receiving the first transactional data from the point of sale further comprising receiving first transactional data from an online shopping website.

28. The method of claim 18, further comprising automatically reconciling any discrepancy.

29. A system for automatically identifying and reconciling a discrepancy resulting from a sale of a gift card, comprising:
a first source that generates an initial request related to the initial sale of a gift card and first transactional data of the gift card sale;
a second source that authorizes the request for the initial sale of the gift card and generates second transactional data of the authorization;
a third source that receives funds for the initial sale of the gift card from the first source and generates transactional data of received funds; and
a central reconciler that receives the first transactional data from the first source, the second transactional data from the second source, and the third transactional data from the third source and automatically identifies any discrepancy of the first transactional data, the second transactional data and the third transactional data.

30. The system of claim 29, wherein the first source is a point of sale.

31. The system of claim 30, wherein the point of sale is in a store, a shopping center or a mall.

32. The system of claim 30, wherein the point of sale is a service booth or kiosk.

33. The system of claim 32, wherein the service booth or kiosk is in a store, a shopping center or a mall.

34. The system of claim 29, wherein the point of sale is an online shopping website.

35. The system of claim 29, wherein the second source is a processor.

36. The system of claim 29, wherein the third source is a bank.

37. The system of claim 29, wherein the central reconciler generates a report identifying any discrepancy.

38. The system of claim 37, wherein the central reconciler provides the report to a user on-demand using menu-driven selections or options.

39. The system of claim 37, the central reconciler being configured to allow a user access to the report via a standard network connection including the Internet.

40. The system of claim 29 being configured to automatically identify any discrepancies without reliance on user input.

41. The system of claim 29, wherein the central reconciler automatically reconciles any discrepancy.

42. A system for automatically identifying and reconciling a discrepancy resulting from a sale of a gift card, comprising:
a point of sale that generates a request related to the initial sale of a gift card and first transactional data of the initial gift card sale;
a processor that authorizes the request for the initial gift card sale and generates second transactional data of the authorization;
a bank that receives funds for the initial gift card sale from the point of sale and generates transactional data of received funds; and
a central reconciler that receives first transactional data from the point of sale, second transactional data from the processor, and third transactional data from the bank, and automatically identifies any discrepancies of the first, second and third transactional data.

43. The system of claim 42, wherein the point of sale is a point of sale at a store, a shopping center or a mall.

44. The system of claim 42, wherein the point of sale is a service booth or kiosk.

45. The system of claim 44, wherein the service booth or kiosk is in a store, a shopping center or a mall.

46. The system of claim 42, wherein the point of sale is an online shopping website.

47. The system of claim 42, wherein the central reconciler generates a report identifying any discrepancy.

48. The system of claim 47, wherein the central reconciler stores the report.

49. The system of claim 47, wherein the central reconciler provides the report to a user on-demand via menu-driven selections or options.

50. The system of claim 47, wherein the central reconciler allows a user access to the report via a standard network connection including the Internet.

51. The system of claim 42, wherein the central reconciler automatically identifies discrepancies without reliance on user input.

52. The system of claim 42, wherein the central reconciler automatically reconciles any discrepancy.
